(19) United States
(12) Patent Application Publication
(10) Pub. No.: US 2003/0177031 A1
(43) Pub. Date: Sep. 18, 2003

(54) Data management of patient medical information for use with an implantable medical device

(75) Inventor: Shahram Malek, Plymouth, MN (US)

Correspondence Address: MEDTRONIC, INC., 710 MEDTRONIC PARKWAY NE, MS-LC340, MINNEAPOLIS, MN, 55432-5604, US

(73) Assignee: Medtronic, Inc., Minneapolis, MN

(21) Appl. No.: 10/099,444

(22) Filed: Mar. 15, 2002

(51) Int. Cl. G06F 17/60

(52) U.S. Cl. 705/2

(57) ABSTRACT

A method and system for the collection and centralized storage of medical information stored in implantable medical devices and associated programming devices. The system comprises a clinician programmer, a patient programmer, an implanted medical device, and a communication network for storing data found on these devices into a central database for report generation.

### FIELD OF THE INVENTION

The present invention relates generally to a method and system for electronic data management of patient medical information. More particularly, this invention allows for the collection of medical information from an implantable medical device and associated programming devices into a centralized database for analysis and report generation.

### BACKGROUND OF THE INVENTION

The medical device industry provides a wide variety of electronic and mechanical devices for treating patient medical conditions. Implantable medical devices are commonly used today to treat patients suffering from various aliments such as pain, spasticity, and cancer. Clinicians use implantable devices separately or in combination with each other to provide the most effective therapy.

Implantable medical devices include pacemakers, defibrillators, neurostimulators, and drug pumps. These devices provide treatment by delivering electrical stimulation or therapeutic drugs to various portions of a patient's body. In the case of providing electrical stimulation, an implantable neurostimulator (“INS”) is implanted within a patient's body. The implantable neurostimulator is coupled to one or more electrodes that provide electrical energy to select portions of a patient's body. In the case of providing therapeutic drugs to a patient, a pump is implanted within the patient's body. The pump is coupled to a catheter that delivers therapeutic drugs to select portions of the patient's body.

In order to monitor, adjust, and collect data regarding a patient's therapy from an implantable medical device, various controllers have been developed that communicate via telemetry with the implantable medical devices. These controllers are typically computers that can communicate with the implantable medical device. Two such controllers that are used with implantable medical devices are clinician programmers and patient programmers. Both clinician programmers and patient programmers provide users with the ability to communicate with the implantable medical device. The clinician programmer is provided with full functionality whereas the patient controller is provided with limited functionality. The setup is by design as clinicians utilize the clinician programmer to program the therapy regiment whereas the patient controller is used by a patient to make changes to the therapy regiment within defined limits as established by the clinician.

Both the clinician programmer and the patient programmer may independently contain valuable information that can be useful in determining the effectiveness of the treatment regiment. Presently, the data must be viewed separately as the data is not contained in centralized database. Therefore, the only way to view all of the data is to separately view the data from each device. The viewing of all of the information from all of these devices simultaneously and frequently is cost prohibitive and not practical as patients and clinicians have busy schedules and can not meet at great frequencies.

There exists, therefore, a significant need for a method and system to collect the information from all of the devices involved in the therapy into a centralized database that can be used to analyze and generate comprehensive reports regarding a patient's therapy. The present invention overcomes these and other disadvantages of the prior art.

### BRIEF SUMMARY OF THE INVENTION

According to an embodiment, a data management system of the present invention includes a clinician programmer, a patient programmer, an implantable medial device, and a network for transmitting data from the patient programmer and the clinician programmer to a server to store data in a centralized database.

Additionally, according to a second embodiment, a method of collecting data from an implantable medical device system is disclosed. The method receives input from a first device, the first device comprising data from the implantable medical device. Next, the method receives input from a second device, the second device comprising data from a user. The first device and the second device are connected to a network server to store the data in a database. The server can generate reports from the database based on a users request for data.

### BRIEF DESCRIPTION OF THE DRAWINGS

These and other advantages and features will become apparent upon reading the following detailed description and referring to the accompanying drawings in which like numbers refer to like parts throughout and in which:

FIG. 1A is a schematic diagram of a clinician and patient programmer as used with an implantable neurostimulator in an embodiment of the present invention.

FIG. 1B is schematic diagram of a clinician programmer and a patient programmer connecting to a network in an embodiment of the present invention.

FIG. 1C is schematic diagram of a patient programmer connecting to a network in an embodiment of the present invention.

FIG. 2A-2B are multiple view diagrams of the clinician programmer in accordance with an embodiment of the present invention.

FIG. 2C is a block diagram of a clinician programmer in accordance with an embodiment of the present invention.

FIG. 3 is a block diagram of a patient programmer in accordance with an embodiment of the present invention.

FIG. 4 is block diagram of a remote telemetry unit in accordance with an embodiment of the present invention.

FIG. 5 is a flow chart depicting the connection of the clinician programmer and the patient programmer with a server.

FIG. 6 is a flow chart depicting the authentication of data from a remote device in accordance with an embodiment of the present invention.

FIG. 7 is flow chart depicting the synchronization of data between a server and remote devices in accordance with a preferred embodiment of the present invention.

### DETAILED DESCRIPTION OF THE INVENTION

Although the preferred invention is shown for use with an implantable electrical stimulation system, those skilled in the art will appreciate that the data management system of the present invention may also be used with any implantable device such as drug delivery system, or even a combination electrical stimulation/drug delivery system.

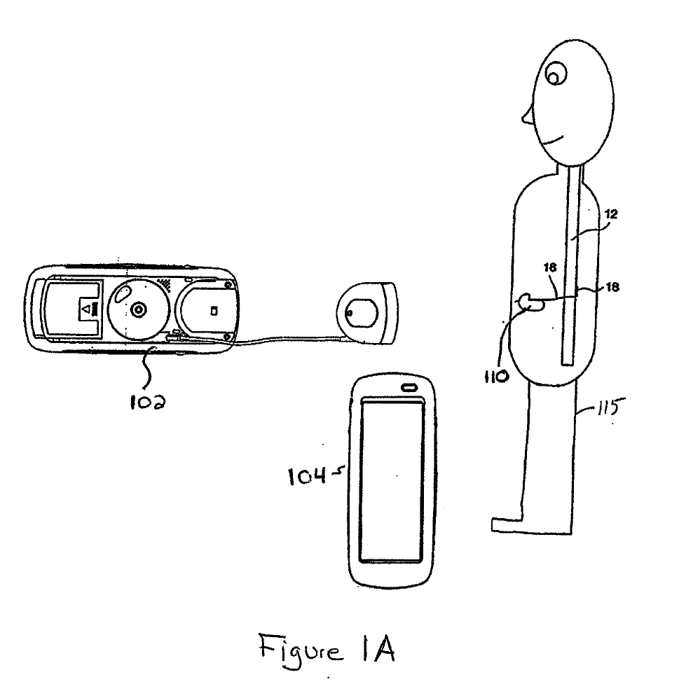

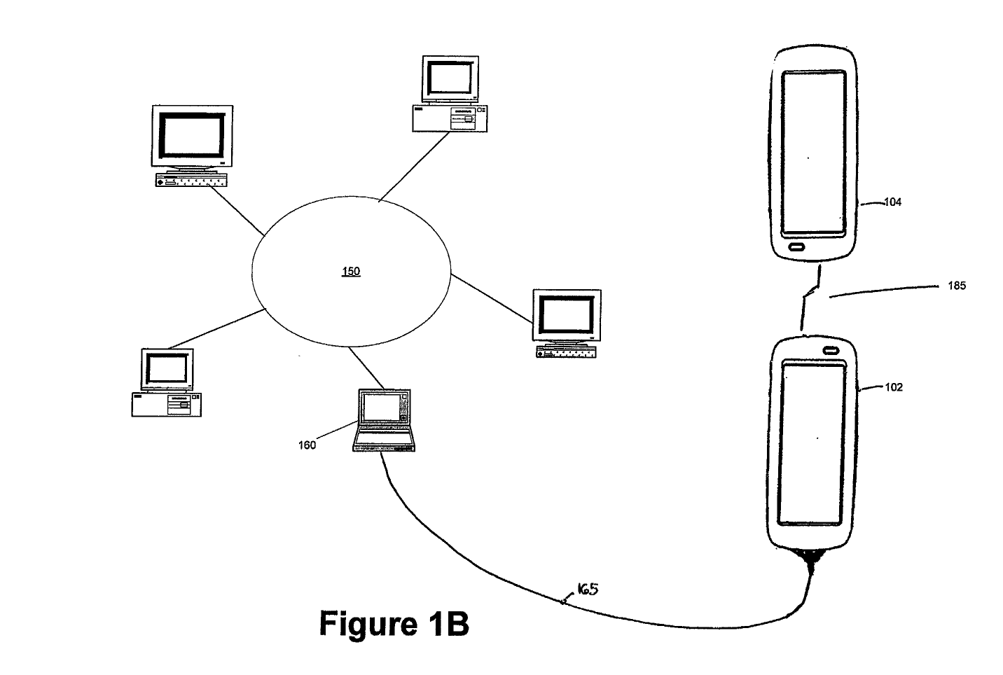

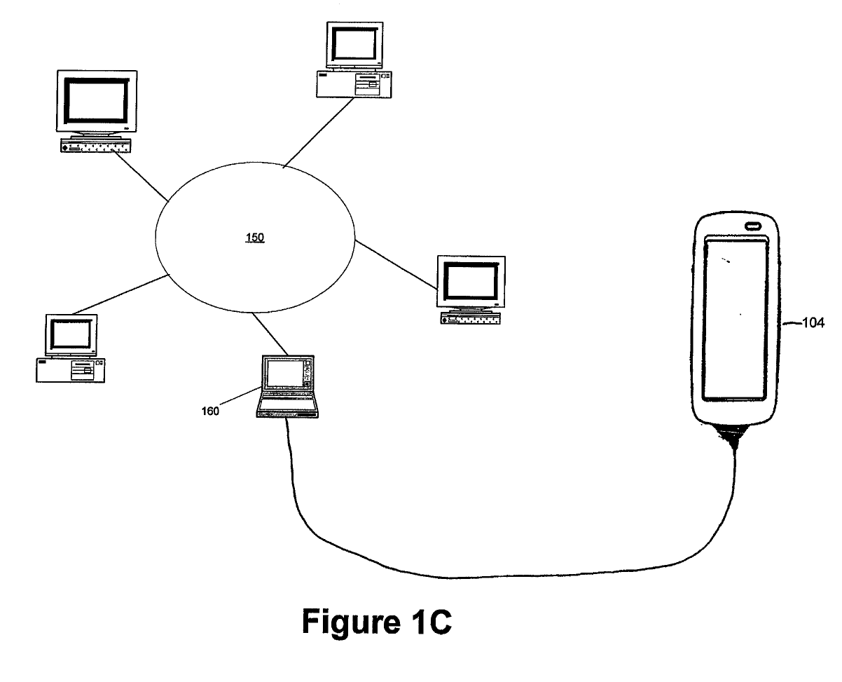

Referring to FIG. 1A, the data management system of the present invention generally includes a clinician programmer 102, a patient programmer 104, an implantable medical device 110, and a network 150, (FIG. 1B), for the transfer of data to a centralized database. Those skilled in the art will appreciate that the clinician programmer 102 and patient programmer 104 may be portable hand-held devices but are not limited to such devices. In addition, the system of the present invention is shown in use with an implantable neurostimulator, but those skilled in the art will appreciate that the system of the present invention may be used generally with any sort of implantable medical device including, but not limited to neurostimulators, drug delivery devices, pacemakers, defibrillators, and cochlear implants. As shown in FIG. 1A, the clinician programmer 102 and the patient programmer 104 allow for the adjusting and monitoring of the implantable neurostimulator 110 during therapy execution with the patient 115. Each of these components may be powered by separate power sources such as rechargeable batteries. The implantable neurostimulator 110 may be placed in any number of locations within the body, including the abdominal region. The implantable neurostimulator 110 is coupled to a lead 16 that terminates in one or more electrodes 18 that deliver the desired stimulation therapy to the body. In the exemplary embodiment of FIG. 1, the electrodes 18 are positioned to stimulate a spinal cord 12 of patient 115.

In the embodiment where the implantable medical device 110 is a neurostimulator, the device may be a signal generator having a processor or like circuitry. For example, signal generator may take the form of commercially available signal generators like Itrel 7, X-trel 7, or Mattrix 7 (manufactured by Medtronic, Inc. of Minneapolis, Minn.), which are incorporated herein by reference. Where the implanted medical device 110 is a drug delivery system, the implanted drug delivery system would generally consist of a drug delivery pump coupled to one or more catheters having drug delivery ports on the distal ends. Those skilled in the art will appreciate that the clinician programmer 102 and the patient programmer 104 are suited for uses with any known or future developed implantable medial device 110. Those skilled in the art will also appreciate that the implanted medical device 110 for use with the present invention can take many forms and embodiments. For example, the implanted medical device 110 may be a system that provides a combination of electrical stimulation and drug delivery. FIG. 1B and the particulars of the individual components of the electronic data management of the present invention are discussed in further detail below.

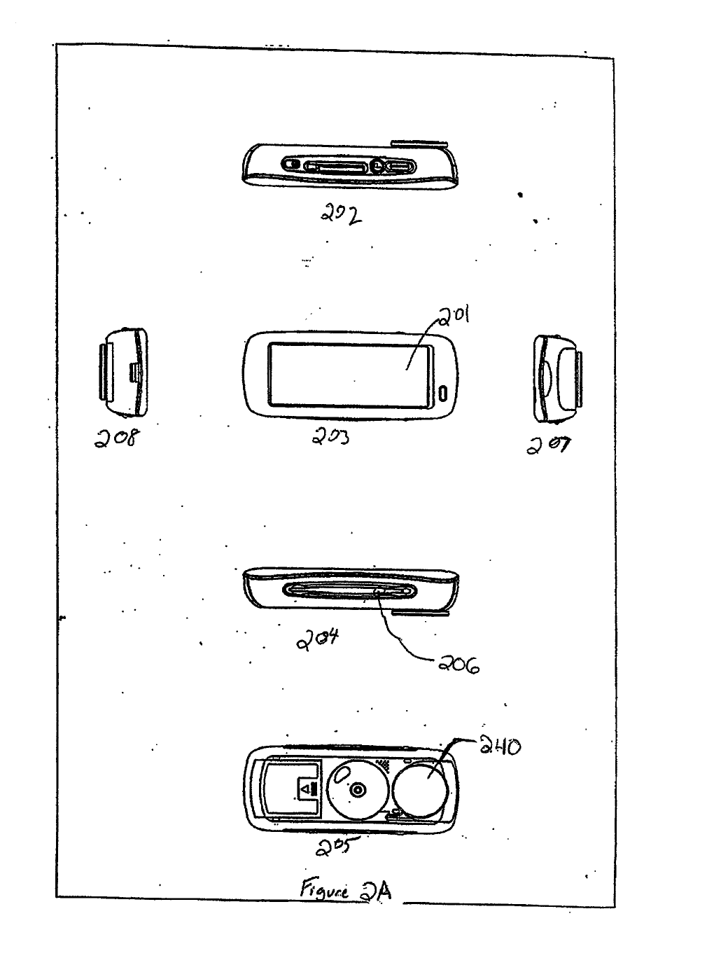

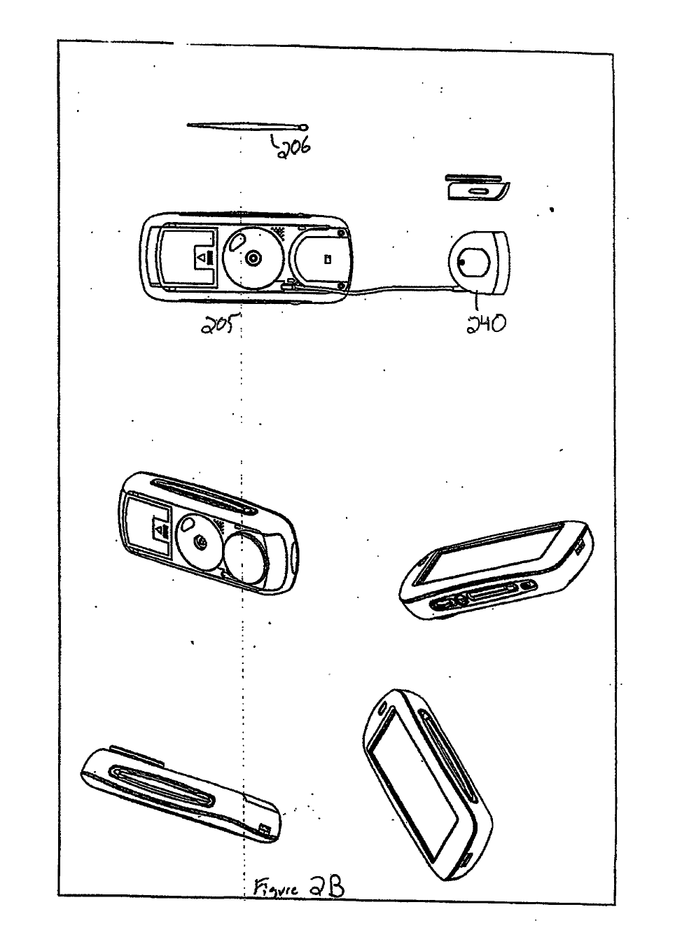

FIG. 2A depicts views of the clinician programmer 102 including a front view, 203, a top view 202, a bottom view 204, a back view 205, a left side view 208, and right side view 207. The clinician programmer 102 is preferably a portable computing device having a user interface. The user interface preferably includes a screen display 201 that is touch sensitive to a pointing device 206, similar to that of a Personal Digital Assistants (PDA) available today. On the dorsal side of the clinician programmer 102 is an area to receive and hold the remote telemetry unit 240. FIG. 2B illustrates how the remote telemetry unit 240 is stored within the dorsal side of the clinician programmer 102.

FIG. 2C depicts the general componentery of the clinician programmer 102, which includes a user interface 260, a processor 265, a transmitter 215, and a receiver 220. The clinician programmer 102 acts as the control interface to the implantable medical device 110, which is generally directed by the computer software application in the clinician programmer 102. The application program software for handling the functionality of the clinician programmer 102 is stored in memory 225. In addition, the memory 225 of the clinician programmer 102 may contain performance parameters of the implantable medical device 110. The data contained in clinician programmer memory 225 may be useful in assembling comprehensive reports on the status of the therapy, and the equipment administering the therapy to the patient. The present invention would allow for all the data that is logged inside the clinician programmer on a compact flash card, in flash memory, or in RAM memory of the clinician programmer 102 to be synchronized and stored in a centralized database.

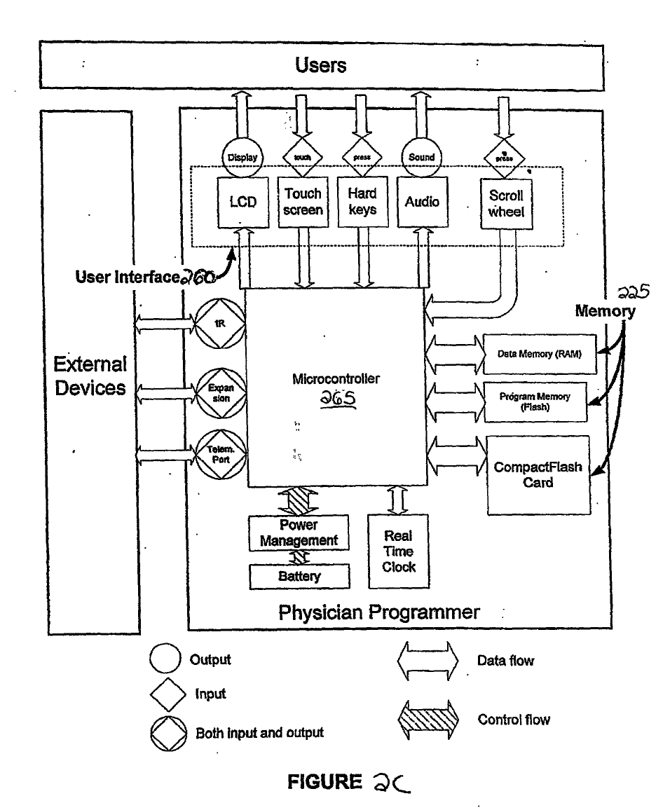

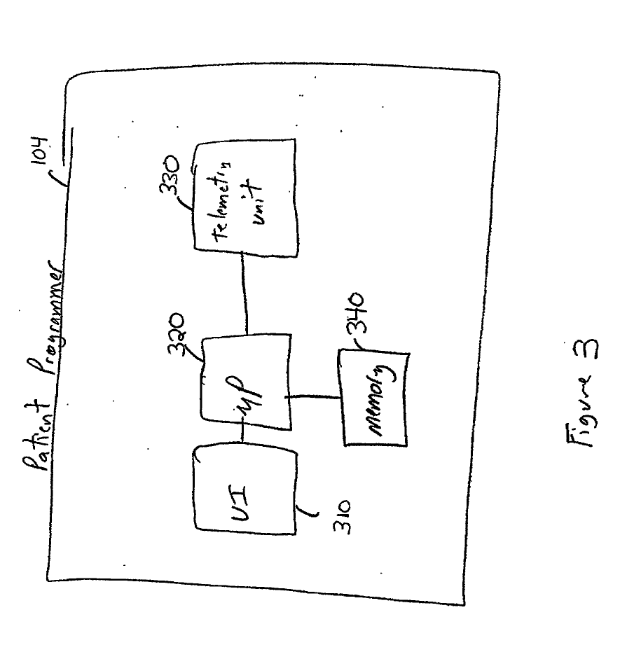

As shown in FIG. 3, the patient controller 104 is preferably a computing device, such as a portable computer or personal digital assistant, having a user interface 310. Patient programmer 104 is similar to clinician programmer 102 except that it has limited functionality. Typically, patient programmer 104 will be limited such that the patient may adjust settings of the implanted medical device 110 only within a range, such as that specified by the treating clinician. The patient programmer 104 includes similar circuitry such as a microprocessor 320 and memory 340 as that of the clinician programmer 102. The patient programmer 104 also preferably includes an internal telemetry unit 330 that is similar to the remote telemetry unit 240 of the clinician programmer 102.

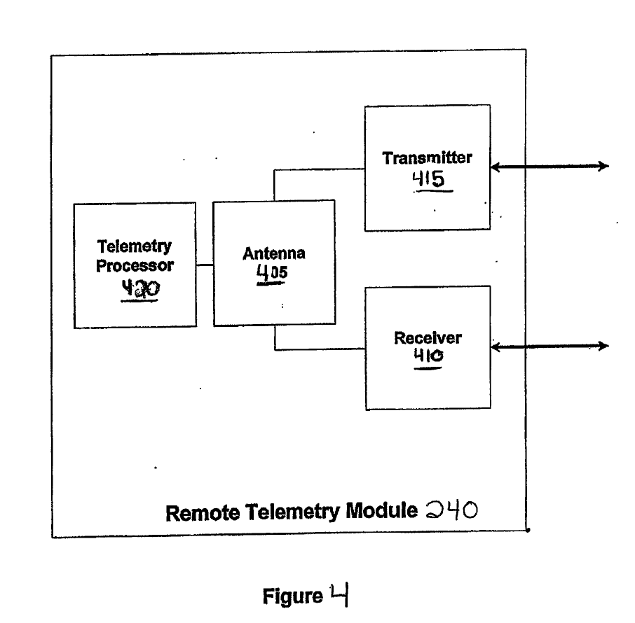

As shown in FIG. 4, the remote telemetry unit 240 is a relatively small device used to conveniently provide communication between the clinician programmer 102 and the implanted medical device 110. Remote telemetry unit 240 generally includes a telemetry coil 405, a receiver 410, a transmitter 415, and telemetry processor 420. Telemetry is preferably conducted at a frequency in the range from about 150 KHz to 200 KHz using a medical device protocol such as described in U.S. Pat. No. 5,752,977 “Efficient High Date Rate Telemetry Format For Implanted Medical Device” issued to Grevious et al. (May 19, 1998). The telemetry coil 405 can be located inside the housing of the remote telemetry unit 240 or attached to the outside of the housing. The receiver 410 provides a digital pulse representing the Radio Frequency (RF) modulated signal received from the clinician programmer 102 and the implanted medial device 110. The transmitter 415 generates an RF modulated signal from the digital signal generated by the telemetry processor 420. The telemetry processor 420 can be a state machine configured on an ASIC with the logic necessary to decode telemetry signal during reception. The telemetry processor 420 also provides the logic necessary during transmission.

The telemetry module of the patient programmer 104 provides bi-directional communications between the implantable medical device 110 and the patient controller 104. The telemetry module 330 of the patient programmer 104 also generally comprises a telemetry antenna, a receiver, a transmitter, and a telemetry processor (components not shown). Telemetry modules are generally know in the art and are further detailed in U.S. Pat. No. 5,752,977, entitled “An Efficient High Data Rate Telemetry Format For Implanted Medical devices issued to Grevious et al. (May 19, 1998), which is incorporated herein by reference in its entirety.

Referring back to FIG. 1B depicted is a schematic diagram illustrating clinician programmer 102 connected to a computer network 150 through a computer 160. Those skilled in the art will recognize that computer 160 could be any general-purpose computing device capable of connecting and transferring data to and from a network. The connection 165 of the clinician programmer 102 to the computer 160 may be accomplished through the use of a serial cable, as illustrated. Those skilled in the art will recognize that the connection 165 between the clinician programmer 102 and the computer 160 may be accomplished in many ways that may include, for example and without limitation, the use of USB ports, infrared ports, modem connections, and wireless connections.

In an embodiment of the present invention, patient data from the clinician programmer 102 may be synchronized with patient data on the computer 160. The synchronization process maintains data consistency and integrity between the computer 160 and the clinician programmer 102 as the latest information stored on the clinician programmer 102 is transferred and stored on the computer 160, and vice versa. Through synchronization the information stored in the clinician programmer will be available for review on computer 160. The information stored in computer 160 may be placed in a database for easy access. Additionally, through synchronization, information may be transferred to the clinician programmer 102 from the network 150 and will be available to the clinician programmer 102 after synchronization.

Computer 160 may be operated in a network environment so that computer 160 may be connected to other computers or servers. As shown in FIG. 1B, computer 160 is connected to network 150. In a business environment, network 150 may be a local area network providing connections to the Internet via a Wide Area Network. In a patient home user environment, network 150 may be an Internet Service Provider's Network enabling computer 160 access to the World Wide Web. Those skilled in the art will recognize that the connection of computer 160 to the Internet may take many different forms and embodiments. The connection of computer 160 to the Internet allows for the information stored in computer 160 to be accessible by any remote computer connected to the Internet. Additionally, the database information collected on computer 160 from clinician programmer 102 can be stored in different databases located on different severs.

Patient programmer 104 can be synchronized to the clinician programmer 102 or to computer 160. The communication between clinician programmer 102 and patient programmer 104 may be accomplished through the use of low-power RF or IR signaling 185 as illustrated in FIG. 1B. Additionally, those skilled in the art will recognize that the connection between the clinician programmer 102 and the patient programmer 104 may also be made through use of any number of ways including, but not limited to, USBA connectors, RS 232 cables, infrared transmitters, or wireless devices. This communication ability allows the clinician programmer 102 and patient programmer 104 to synchronize information. Optionally, the patient programmer 104 may be synchronized with the computer 160 similar to that of the clinician programmer 102, as shown in FIG. 1C. The patient controller 104 may be coupled to the network 150 either directly through a modem or may be networked to a computer 160 that is coupled to the network 150 through know techniques.

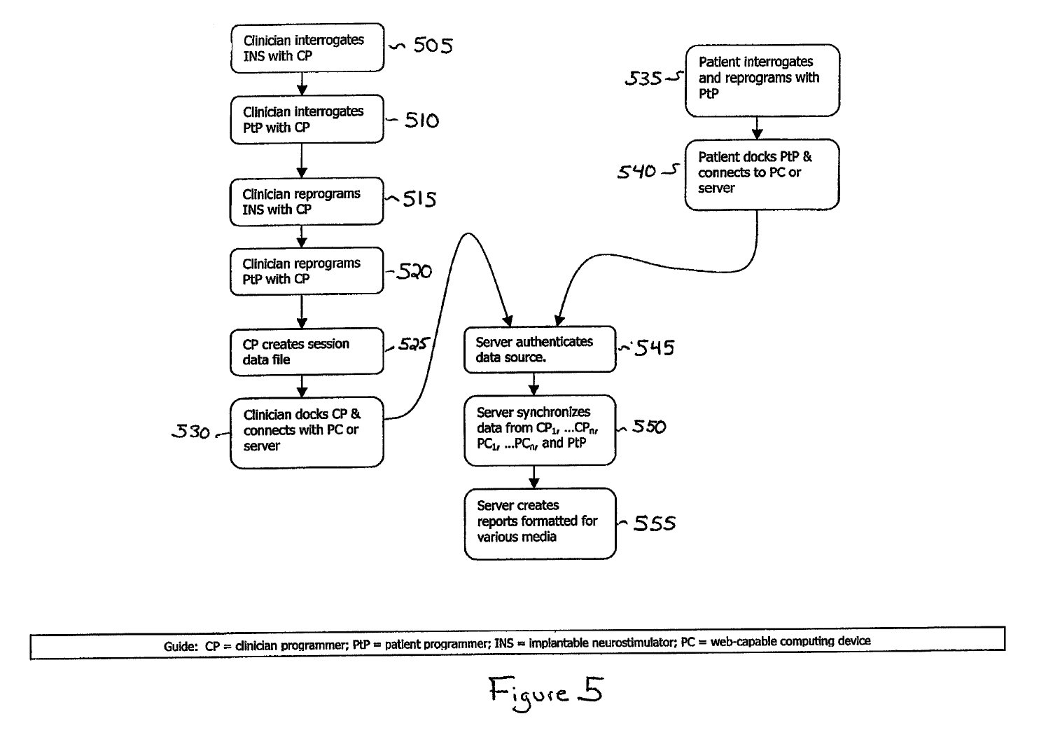

FIG. 5 is flow chart depicting the process of creating various reports from a centralized database, the data provided by the implantable device 110, the clinician programmer 102, and the patient programmer 104. At step 505, a clinician interrogates the implantable neurostimulator 110 with the clinician programmer 102. The implantable neurostimulator 110 may provide the clinician programmer 102 with certain diagnostic information such as parameter settings (e.g. stimulation frequency, stimulation pulse amplitude, stimulation pulse width, electrode configuration, etc.), patient diagnostic data (e.g., usage data), system diagnostic data, (e.g., battery status, estimated longevity of implanted device, lead system integrity, load impedance, etc.), data on device usage, the state of the device, and whether a valid communication channel exists, and the like.

At step 510, the clinician interrogates the patient programmer 104 with the clinician programmer 102. The patient programmer 104 may provide the clinician programmer 102 with similar information from the implantable medical device 110, but may also provide additional data such as the actual therapy programs used by the patient, the number of requests for increased and decreased therapy dosages, and the frequency of patient interaction with implantable medical device 110.

At step 515, the clinician reprograms the implantable neurostimulator 110 with the clinician programmer 102. Similarly, at step 520 the clinician reprograms the patient programmer 104 with the clinician programmer 102. The reprogramming may be necessary due to changes in the therapy treatment. Additionally, reprogramming may be necessary after updates to the software residing on both the clinician programmer 102 and the patient programmer 104 are implemented.

At step 525, the clinician programmer 102 creates a session data file. The data session file may contain all the information stored in the clinician programmer 102 as provided by the INS device 110 and the patient programmer 104.

At step 530, the clinician connects or docks the clinician programmer 102 to a computer or server to transfer the data file to the network and in particular to a database on the network. Those skilled in the art will recognize that the connection to the network may be made in numerous ways in order to transfer the data file to network database.

On a parallel path to that of the clinician's actions, the patient may interrogate and reprogram the implantable medical device 110 with the patient programmer 104 as shown in step 535. At step 540, the patient docks or connects the patient programmer 104 to a computer or server to transfer data to the network and in particular to a database on the network. This parallel path may ensure that the current information contained in the patient programmer 104 is stored in the database no the network. For example, if a patient is on an extended vacation, a clinician may not be able to interrogate the patient programmer 104 with the clinician programmer 102. In this situation, the patient can connect the patient programmer 104 to a personal computer or sever and directly synchronize the data on the patient programmer with the data stored in the network database. This will allow those who access the network database to have the latest information for analysis and report generation.

At step 545, the server authenticates the data source whether from the data is being sent from the clinician programmer 102 or the patient programmer 104. The authentication process is to ensure that the data about to be transferred into the network database is from a recognized device.

At step 550, the server synchronizes data from the clinician programmer 102, and or the patient programmer 104. At step 555, the data can be analyzed and reports formatted for various media incorporating the collected data from any computer device capable of accessing and displaying information from the network.

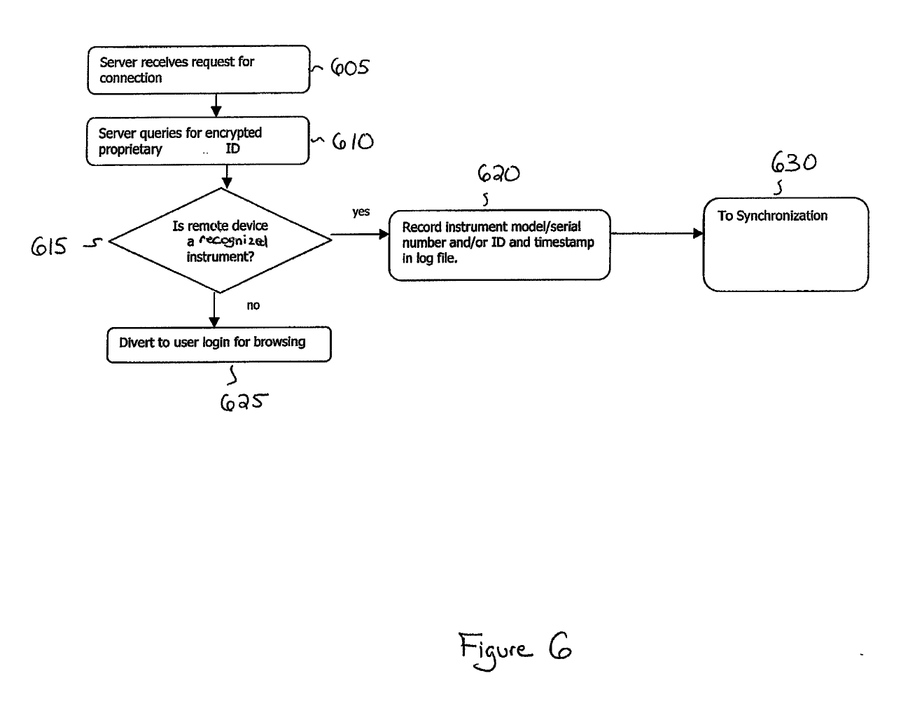

FIG. 6 is flow chart depicting a method of authenticating the data as discussed above. At step 605, the server receives a request for connection. This request for connection may be from the clinician programmer 102 or the patient programmer 104. At step 610, the sever queries the connected device for an encrypted ID. The server then determines in step 615 if the remote device is a recognized instrument. If the device is a recognized instrument, then the server records the instrument model/serial number and/or ID along with a timestamp in a log file. If the remote device is not found to be a recognized instrument in step 615, then the request is diverted to a user login screen for browsing. Following the recording of the instrument model/serial number, ID, and timestamp in the log file in step 620, the data is approved for synchronization in step 630.

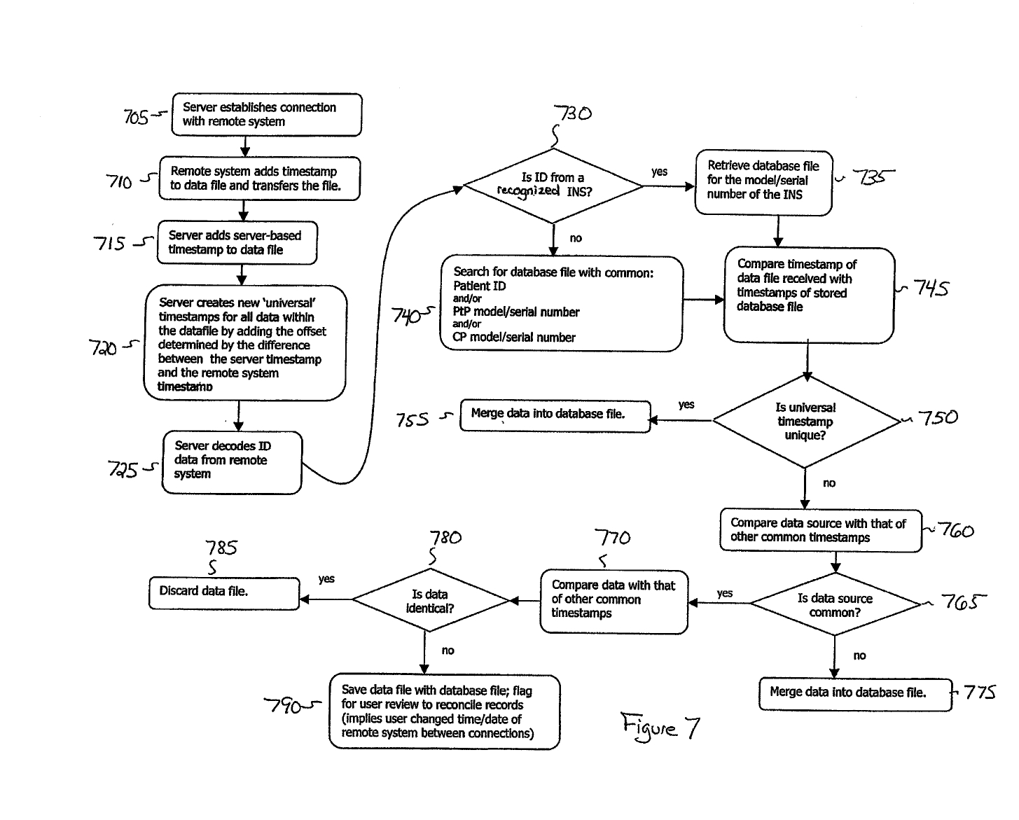

FIG. 7 depicts a flow chart demonstrating the steps for synchronization of data from a clinician programmer 102 or a patient programmer 104 as embodied in the present invention. As shown in step 705, the server establishes a connection with the remote system. The remote system may comprise the patient programmer 102, the patient programmer 104, or both.

In step 710, the remote system adds a timestamp to the data file and transfers the data file to the server. The server after receipt of the data file adds its own timestamp to the data file in step 715. In step 720, the server creates a new universal timestamp for all data within the data file by adding the offset determined by the difference between the server timestamp and the remote system timestamp.

In step 725, the server decodes the ID data from the remote system.

In step 730, the server determines whether the ID is from a recognized INS system. If the ID is from a recognized INS system then the server retrieves a database file for the model/serial number of the INS. If the ID is not from a recognized INS system, step 730, then the server searches for a database file with common patient ID's, patient programmer model/serial numbers, and/or clinician programmer model and serial numbers in step 740.

In step 745, the server compares the timestamp of the data file received with the timestamps of the stored database files. The server in step 750 determines whether the universal timestamp is unique. If the universal timestamp is unique then in step 755 the date is merged into the database file. If the universal timestamp is step 750 is not unique, then the server compares the data source with that of other common timestamps in step 760. The server in step 765 determines whether the data source is common. If the data source is not common then the data is merged into the database file in step 775. If the data source is common, then in 770 the server compares the data with that of other common timestamps. The comparison with other common timestamps is to determine whether the data is identical. The server in step 780 determines whether the data is identical. If the data is identical the data is discarded in step 785. If the data is not identical then in step 790 the data file is saved with the database file in step 790 and is flagged for user review.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method of data management for an implantable medial device, the method comprising the steps of:
(a) receiving input from a first device, the first device comprising first data from the implantable medical device;
(b) receiving input from a second device; the second device comprising second data from a user;
(c) transferring the first data and the second data over a network; and
(d) storing the first data and the second data in a database coupled to the network.

2. The method of claim 1 wherein the step of receiving input from a first device comprises the step of receiving input from a clinician programmer.

3. The method of claim 1 wherein the step of receiving input from a first device comprises the step of receiving input via a communication medium selected from the group consisting of a Universal Serial Bus (USB) link, an infrared link, a modem link, and a wireless link.

4. The method of claim 1 wherein the step of receiving input from a second device comprises the step of receiving input from a patient programmer.

5. The method of claim 1 wherein the step of receiving by the first device includes the step of receiving the first data via telemetry.

6. The method of claim 1 wherein the step of receiving input from a first device comprises the step of receiving by the first device the first data from the implantable medical device.

7. The method of claim 5 wherein the step of receiving by the first device includes the step of receiving from the implantable medical device selected from the group consisting of a neurostimulator, a drug delivery device, a pacemaker, a defibrillator, and a cochlear implant.

8. The method of claims 1 wherein the step of transferring includes the step of transferring the first data and the second data over an Internet.

9. The method of claim 2 wherein the clinician programmer is a hand-held clinician programmer.

10. The method of claim 4 wherein the patient programmer is a hand-held patient programmer.

11. A system for gathering patient medical information for an implantable medical device, the system comprising in combination:
(a) a first input for receiving data from a patient programmer used by a patient to interact with the implantable medical device;
(b) a second input for receiving data from a clinician programmer used by a clinician to interact with the implantable medical device; and
(c) an output to a network for transmitting data from the patient programmer and the patient programmer in a network transmission to a database.

12. The system of claim 11 wherein the network is an Internet.

13. The system of claim 11 wherein the first input is selected from the group consisting of a Universal Serial Bus (USB) link, an infrared link, a modem link, and a wireless link.

14. The system of claim 11 wherein the second input is selected from the group consisting of a Universal Serial Bus (USB) link, an infrared link, a modem link, and a wireless link.

15. The system of claim 11 wherein the implantable medical device is selected from the group consisting of a neurostimulator, a drug delivery device, a pacemaker, a defibrillator, and a cochlear implant.

16. The system of claim 11 wherein the patient programmer is a hand-held patient programmer.

17. The system of claim 11 wherein the clinician programmer is a hand-held clinician programmer.

18. A system for gathering patient medical information for an implantable medical device, the system comprising in combination:
(a) a patient programmer used by a patient to interact with the implantable medical device;
(b) a clinician programmer used by a clinician to interact with the implantable medical device;
(c) a network for transmitting data from the patient programmer and the clinician programmer in a network transmission;
(d) a server for receiving the network transmission; and
(e) a database for storing the data received by the server.

19. The system of claim 18 wherein the network is an Internet.

20. The system of claim 18 wherein the patient programmer is a hand-held patient programmer.

21. The system of claim 18 wherein the clinician programmer is a hand-held clinician programmer.

22. A method of data management for an implantable medial device, the method comprising the steps of:
(a) interrogating an implantable medical device for a first set of information;
(b) interrogating a patient programmer for a second set of information;
(c) creating a session data file comprising at least a portion of the first and second sets of information; and
(d) transferring the session data file to a server via a network transmission.

23. The method of claim 22 wherein the step of interrogating the implantable medical device includes the step of obtaining diagnostic information from the implantable medical device.

24. The method of claim 22 wherein the step of interrogating the patient programmer includes the step of obtaining diagnostic information from the implantable medical device.

25. The method of claim 22 wherein the step of interrogating the patient programmer includes the step of obtaining information selected from the group consisting of therapy program information, therapy dosage change information, and patient-implantable medical device interaction information.

26. The system of claim 22 wherein the patient programmer is a hand-held patient programmer.
